(19) United States
(12) Patent Application Publication
(10) Pub. No.: US 2011/0079607 A1
(43) Pub. Date: Apr. 7, 2011

(54) SEALANT SYSTEM

(75) Inventor: Carmine Cicero, Staten Island, NY (US)

(73) Assignee: CONSOLIDATED EDISON COMPANY OF NEW YORK, INC., New York, NY (US)

(21) Appl. No.: 12/574,277

(22) Filed: Oct. 6, 2009

(51) Int. Cl. B67D 7/00; B67D 7/74; B65D 35/22

(52) U.S. Cl. 222/1; 222/129; 222/94; 206/219

(57) ABSTRACT

A sealant system is provided having a first container with a hollow interior containing a reaction material. A second container having reactant material is arranged within the hollow interior. To use the sealant system, an operator ruptures the second container releasing reactant material into the hollow interior. The reaction and reactant material are mixed to form a sealing material. The container may include an elongated portion with a removable end to facilitate dispensing of the sealing material.

### BACKGROUND OF THE INVENTION

The subject matter disclosed herein relates to a sealant system and in particular to a self contained sealant system that allows mixing and application of the sealant in the field.

Holes are formed in foundations for a variety of reasons, such as to allow access of utilities, including water and electrical conduits. Typically, the utility is carried in a conduit within the opening or hole. Since the openings in the foundation are positioned underground, water will tend to migrate through the opening and into the basement of the building.

Buildings and facilities are typically connected to a number of utility services, including but not limited to water, electricity, natural gas and propane for example. These utilities are usually provided by external sources and are delivered through an appropriate mechanism such piping of electrical cable for example. For practical and aesthetic reasons, these services are arranged underground and through the buildings foundation.

The entry of the utility services requires holes to be formed in the foundation to accommodate the conduits, which are typically 2 inches (5.08 centimeters) or 4 inches (10.16 centimeters) in diameter. While the holes are sized to closely match the conduit. In areas where water can buildup against the outside of the foundation or within the junction boxes the conduits are coupled to, water can seep into or around the conduit allowing water to enter the basement of the building. To prevent this infiltration by the water, utility personnel apply a sealer material, such as silica containing concrete for example, to fill the gap around the conduit and around the conductors within the conduit. This forms a seal to prevent entry of water.

These sealer materials are usually formed from a two-part mixture of a reaction material, such as a silica based concrete for example, and a reactant material, such as water for example. It is desirable for the sealer material to setup quickly once the reactant material and reaction material are mixed. This allows the utility personnel to apply the sealing material quickly and allow the sealing material to stop any infiltration of water.

A number of issues arise with the used of these sealer materials. Typically, they are hand mixed on-site since they cannot be prepared ahead of time. As a result, utility personnel often waste time searching for a mixing container or water. Often, the utility personnel use their hands to pack the sealer material into the gaps, causing the sealer material to stick-to and ruin their gloves. It is also undesirable to breath in the powdered reactant materials that contain silica. Therefore, the utility personnel need to measure and mix the sealer materials in a well-ventilated area. The utility personnel frequently need to return to the site when inadequate sealer material is applied. Resulting in increased costs, less productivity and dissatisfied customers.

Accordingly, while existing sealer materials and methods of sealing gaps around conduits are suitable for intended purposes, there remains a need for improvements in providing the sealer material in a convenient form that allows a fast application of the appropriate amount of material.

### BRIEF DESCRIPTION OF THE INVENTION

According to one aspect of the invention, a dispensing device for sealants is provided. The dispensing device includes a first container having a generally hollow interior. A reaction material is arranged in the hollow interior. A second container is arranged in the hollow interior. A reactant material is arranged in the second container.

According to another aspect of the invention, a sealant dispensing container is provided. The sealant dispensing container includes a thin walled outer layer defining a first enclosed area, wherein the thin walled outer layer includes a dispensing portion. A thin walled container is arranged within the first enclosed area, wherein the thin walled container defines a second enclosed area. A reaction material is arranged in the first enclosed area. A reactant material is arranged in the second enclosed area.

According to yet another aspect of the invention, a method for sealing a conduit is provided. The method includes the step of disposing a reaction material in a first container. A reactant material is disposed in a second container. The reactant material is transferred into the first container. A sealing material is formed when the reactant material mixes with the reaction material. The sealing material is transferred from the first container.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic plan view illustration of a sealing system in accordance with an embodiment of the invention

FIG. 2 is a flow diagram illustration for operating the sealing system of FIG. 1 in accordance with one embodiment of the invention; and,

FIG. 3 is a flow diagram illustration for operating the sealing system of FIG. 1 in accordance with another embodiment of the invention.

The detailed description explains embodiments of the invention, together with advantages and features, by way of example with reference to the drawings.

### DETAILED DESCRIPTION OF THE INVENTION

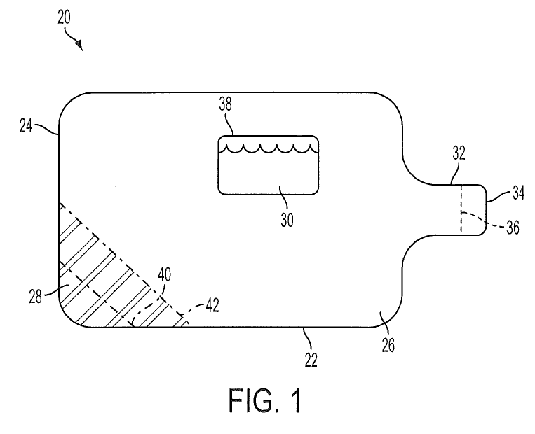

Sealant compounds, such as hydraulic water-stop cement for example, are used to perform repairs or to seal holes, cracks and other openings in foundation walls to prevent the infiltration of water. These sealant compounds typically include reaction materials such as Portland cement, silica sand, and additives that allow for fast cure periods for example. When the reaction material is mixed with an appropriate reactant, such as water for example, the sealant material is formed and may be applied to the desired area. An exemplary embodiment of a self-contained sealing system 20 for applying the sealing material is shown in FIG. 1.

The sealing system 20 includes a container 22. In the exemplary embodiment, the container 22 is formed from a thin walled material. In one embodiment, the container 22 is made from a plastic material, such as polypropylene, polyethylene, or polycarbonate for example, and has a wall thickness of 1 millimeter to 6 millimeters. As will be discussed in more detail below, in one embodiment, the container 22 is flexible and has sufficient wall thickness to allow an operator to rupture a pouch without damaging the wall of the container 22. The container 22 includes a body portion 24 having a hollow interior portion 26. The container 22 is sized to allow a desired quantity of reaction material 28 and reactant material 30 to be arranged within the interior portion 26.

In one embodiment, the container 22 includes an elongated portion 32 having a removable end 34. As will be described in more detail below, the elongated portion 32 provides a convenient dispensing port for the sealing material that allows the operator to apply the sealing material without contaminating their gloves or clothing. In one embodiment, the removable end 34 is integral with the elongated portion 32 and includes a perforated portion 36 which allows the removable end 34 to be removed from the container 22. In other embodiments, the elongated portion 32 may include a threaded portion (not shown) that allows the removable end 34 to couple to the container 22. In one embodiment, the container 22 may include indicia 40, 42 on the body portion 24. The indicia provide a means for the operator to visually determine the amount of sealing material the sealing system 20 may provide. In the exemplary embodiment, the indicia 40 provide enough material to seal a 2-inch (50.8 millimeters) conduit opening and the indicia 42 provides enough material to seal a 4-inch (101.6 millimeter) conduit.

In the exemplary embodiment, the reaction material includes Portland cement and silica, such as Quikrete Cement or Hydraulic Water-Stop manufactured by The Quikrete Companies, Inc.

The reactant material 30 is contained in container or pouch 38. In the exemplary embodiment, the pouch 38 is a thin walled enclosure made from a pierce-able or rupture-able material. In one embodiment the pouch 38 is made from a plastic material, such as polyethylene, polypropylene, or polycarbonate for example.

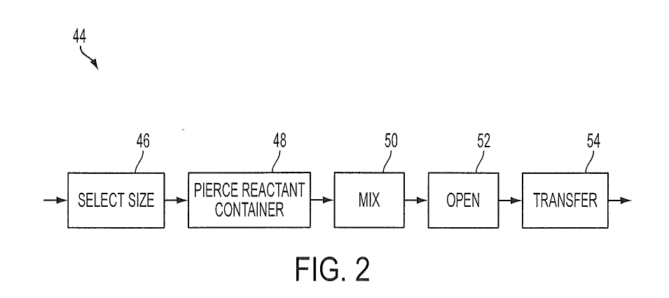

Referring now to FIG. 2, a method 44 of operating the sealing system 20 is illustrated. The method 44 starts in block 46 with the operator selecting the desired amount of sealing material. In the exemplary embodiment, the sealing system 20 is provided in predetermined amounts, such as with the appropriate amount of sealing material to seal a 2-inch (50.8 millimeter) conduit and a 4-inch (101.6 millimeter) conduit for example. Once the container 22 having the desired amount of sealing material is selected, the operator pierces the pouch 38 in block 48. The piercing of the pouch 38 may be accomplished in several ways, such as having the operator squeeze the pouch 38 through the container 22 wall causing the pouch 38 walls to rupture. The piercing of the pouch 38 releases the reactant material 30 into the interior portion 26. Once in the interior portion 26, the reactant material 30 and the reaction material 28 may be mixed in block 50.

When the reactant material 30 and reaction material 28 mix, the sealant material is formed. The method 44 the proceeds to block 52 where the operator opens the container 22, such as by tearing off the removable end 34 for example. With the container 22 open, the operator may dispense the sealant material through the elongated portion 32 in block 54.

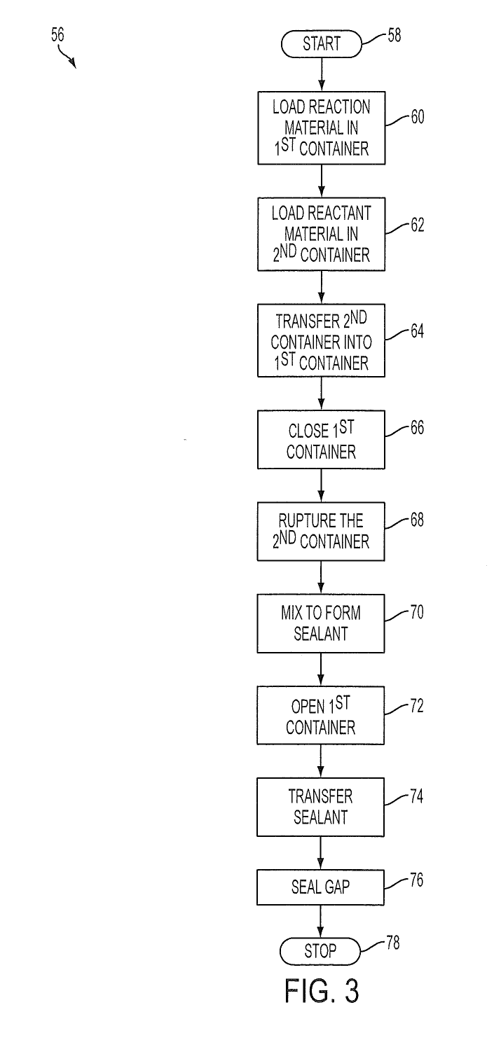

Referring now to FIG. 3, another embodiment of a method 56 for operating the sealing system 20 is illustrated. The method 56 starts in start block 58 and proceeds to block 60 where the reaction material 28 (e.g. cement) is placed in a first container, such as container 22 for example. In one embodiment, the first container includes indicia that assist the operator in placing the desired amount of reaction material 28. The method 56 then proceeds to block 62 where the reactant material 30 (e.g. water) is placed into a second container, such as pouch 38 for example. The second container is arranged in the first container in block 64 and the first container is closed in block 66 to form the sealing system 20.

With the sealing system 20 configured, the operator may store or transport the first container until a need for sealing material arises. The method 56 then proceeds to block 68 where the operator ruptures the second container. This releases the reactant material and allows the mixing in block 70 to form the sealant material. The method 56 then proceeds to block 72 where the operator opens the first container. The sealing material is dispensed in block 74 to the desired area, such as the gap around a conduit and the area in the conduit not occupied by the conductors. The area is sealed in block 76 and the method terminates in block 78.

It should be appreciated the sealing system 20 and the methods of operation disclosed herein may provide a number of advantages to the operator in labor cost savings and minimization of waste. The sealing system 20 may allow the operator to more efficiently dispense the correct amount of sealing material for the desired application, rather than having the operator measure and mix the materials in an open container. The sealing system 20 may also minimize the amount of sealing material that contaminates articles or clothing such as gloves. Further, the sealing system 20 may minimize waste since predetermined and pre-measured amounts of sealing material may be easily transported for use in common applications.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A dispensing device for sealants comprising:
a first container having a generally hollow interior;
a reaction material arranged in said hollow interior;
a second container arranged in said hollow interior; and
a reactant material arranged in said second container.

2. The dispensing device of claim 1 wherein a sealing material is framed with said reaction material and said reactant material are combined.

3. The dispensing device of claim 2 wherein said first container further includes an elongated portion in fluid communication with said hollow interior.

4. The dispensing device of claim 3 wherein said elongated portion includes a removable end

5. The dispensing device of claim 4 wherein said second container includes a means for transferring said reactant material into said hollow interior.

6. The dispensing device of claim 5 wherein said reaction material includes silica.

7. The dispensing device of claim 6 wherein said reactant material is water.

8. A sealant dispensing container comprising:
a thin walled outer layer defining a first enclosed area, wherein said thin walled outer layer includes a dispensing portion;
a thin walled container within said first enclosed area, wherein said thin walled container defines a second enclosed area;
a reaction material in said first enclosed area; and,
a reactant material in said second enclosed area.

9. The dispensing container of claim 8 wherein said thin walled container forms an opening between said first enclosed area and said second enclosed area in response to an external force in said thin walled container

10. The dispensing container of claim 9 wherein said dispensing portion includes a removable end.

11. The dispensing container of claim 10 wherein said reaction material includes silica.

12. The dispensing container of claim 11 wherein said reactant material is water.

13. A method for sealing a conduit comprising:
disposing a reaction material in a first container;
disposing a reactant material in a second container;
transferring said reactant material into said first container;
forming a sealing material when said reactant material mixes with said reaction material;
transferring said sealing material from said first container.

14. The method of claim 13 further comprising determining a size of an opening to be sealed and selecting said first container having sufficient reaction material to seal said opening

15. The method of claim 14 further comprising applying a force to said first container.

16. The method of claim 15 further comprising rupturing said second container when said force is applied to said first container.

17. The method of claim 16 further comprising injecting said sealing material into said opening

18. The method of claim 17 further comprising mixing said reactant material and said reaction material after rupturing said second container.
